(19) United States
(12) Patent Application Publication
(10) Pub. No.: US 2008/0027982 A1
(43) Pub. Date: Jan. 31, 2008

(54) Indefinite caching expiration techniques

(75) Inventors: Mahesh Subramanian, San Jose, CA (US); Arnold J. Goldberg, Saratoga, CA (US); Scott Bruck, San Jose, CA (US); Yitao Yao, Saratoga, CA (US); Connie Y. Yang, Saratoga, CA (US); Justin Christopher Early, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/495,906

(22) Filed: Jul. 27, 2006

(51) Int. Cl. G06F 17/00

(52) U.S. Cl. 707/103 X

(57) ABSTRACT

Techniques are presented for indefinite caching expiration techniques. A browser page includes a reference to an object. A client browser acquires a version of the browser page on each access attempt by the client to a site associated with the browser page. The browser acquires or downloads the object (along with perhaps a maximum value for the expiration header equivalent to an indefinite expiry) into client cache via the reference on a first access attempt of the browser page and subsequently does not re-request the object from the site; rather, when the object changes the browser page is updated with a new name for the object thereby forcing the browser to re-request and re-acquire the object on demand and just when the object is modified.

### FIELD

The invention relates generally to caching and more particularly to techniques for indefinite cache expiration techniques.

### BACKGROUND

With the pervasive usage of the Internet and the World-Wide Web (WWW) enterprises that supply services are continually looking for ways to improve processing throughput for their products. That is, a user accesses a browser with an Internet connection and attempts to engage the WWW services of enterprises for purposes of conducting business or for purposes of leisure. The more popular a particular WWW service is, the more challenging it becomes for an enterprise to timely and cost-effectively support the WWW service.

Some enterprises will take advantage of caching features that come bundled with conventional browsers in an effort to improve the delivery of their services. With caching techniques, a browser residing on a client of a user can temporarily store data that the user may access repeatedly in local memory of the client. In this manner, when data is accessed two or more times by the browser it can be quickly acquired from the local memory of the client. This results in decreased usage of bandwidth associated with accessing the Internet to reacquire data and results in the user experience increased response times from the browser since the data is in local memory of the client.

One problem associated with caching is that the data stored in cache may become stale at any time subsequent to when the user initially acquired the data. To deal with this, certain types of data that are cached may have caching attributes that instruct the client browser on when and how often the browser should check with the WWW site for updates to the data. In some cases, a browser may check each time access is made to the data stored in cache for an update. Yet, this is inefficient and results in increased traffic emanating from the client and being received at the WWW site that supplies the data.

In other cases, a certain type of data or the browser as a whole may check for updates at predefined intervals, such as every day, every fifteen minutes, etc. This type of technique decreases the bandwidth traffic at the client and the WWW site that supplies the data, but it also may result in less than desired timeliness. That is, some data may be critical to the user or the enterprise supplying it and if it changes the enterprise and the user want to know that it has changed and want to use the newer version of that data.

Consequently, enterprises often tailor the caching attributes to their particular applications, data, and users in an effort to maximize efficiency from both the enterprises perspective and from the perspective of their users. This customization is still often not optimal for the user or the enterprise as discussed above and results in the enterprises expending more human resources in monitoring and supporting the services that they deliver.

### SUMMARY

In an embodiment, content is published via a browser page. The content includes a reference to an object, which is accessible from the browser page via activation of the reference. The browser page is periodically updated by changing an original name to the reference when the object is modified and thereby forcing cache associated with a browser of an accessing client to automatically reacquire the modified object since the original name changed within the browser page.

Other features will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements.

FIG. 1 is a diagram of a method for an indefinite cache expiration technique, according to an example embodiment.

FIG. 2 is a diagram of another method for an indefinite cache expiration technique, according to an example embodiment.

FIG. 3 is a diagram of an object release management system, according to an example embodiment.

FIG. 4 is a diagram of an object versioning system, according to an example embodiment.

FIG. 5 is a diagram of example network-based commerce system or facility which implements various embodiments associated with the invention.

FIG. 6 is a diagram of example applications implemented within some of the components of the network-based commerce system of FIG. 5.

FIG. 7 is a diagram of machine architecture which implements various aspects of the invention, according to an example embodiment.

### DETAILED DESCRIPTION

Methods and systems for indefinite caching expiration techniques are described. In the following description, for purposes of explanation, numerous specific details are set forth in order to provide a thorough understanding of embodiments of the invention. It will be evident, however, to one of ordinary skill in the art that other embodiments of the invention may be practiced without these specific details.

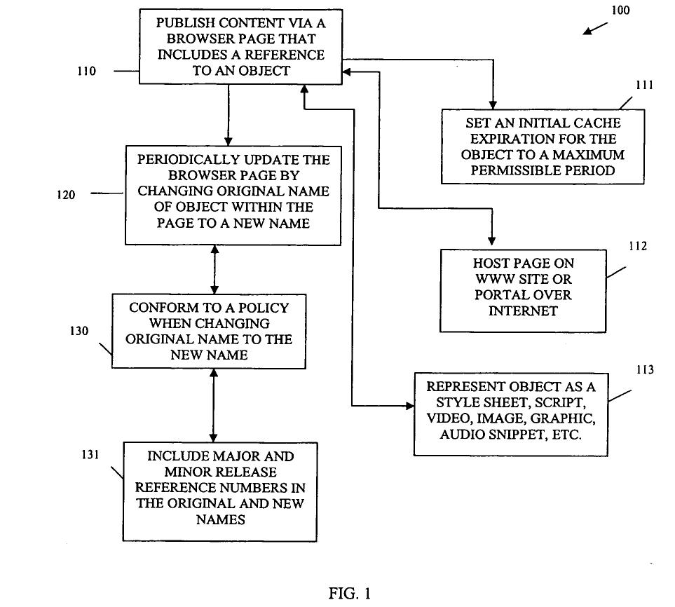

FIG. 1 is a diagram of a method 100 for an indefinite cache expiration technique, according to an example embodiment. The method 100 (hereinafter “indirect caching service”) is implemented in a machine-accessible and/or readable medium and is accessible over a network. The network may be wired, wireless, or a combination of wired and wireless.

The method 100 is referred to as an indirect caching service because it does not directly manage the cache associated with client browsers; rather it indirectly effects or controls when the caching services of client browsers request updates to their caches. In this way and as will be demonstrated more completely herein and below, the indirect caching service is capable of preventing caching services of client browsers from requesting cache updates to objects in cache and capable of updating the clients with objects when they are modified on demand.

Initially, a desired service located over a network, such as the Internet, is hosted at a site, such as a World-Wide Web (WWW) site or portal. The front-end or entry access point to the service is driven by a browser page. That page may be encoded in any data language, such as but not limited to, Hypertext Markup Language (HTML), Extensible Markup Language (XML), Extensible Style Sheets Language (XSL), and others. Features of the service are driven by embedded object references encoded within the browser page. Some example objects may include a JavaScript, a Cascading Style Sheet (CSS), an executable program or script, any other type of style sheet, a video clip, an audio snippet, a graphic, an image, and others. The data associated with the objects are not included within the browser page; rather, references to the locations of the objects are embedded with the browser page.

A client device or machine processes a WWW-enabled browser application and a user activates a link associated with acquiring the desired service. This action takes the browser of the user to the WWW site hosting the browser page of the desired service. Here, the browser downloads the page and the embedded references to the objects. If this is the first access attempt by the user or first access attempt within a given session of the browser, then the browser parses the browser page and activates each of the embedded references for purposes of downloading the objects from their native locations into cache of the client machine.

With this context, the processing of the indirect caching service will now be discussed in detail with reference to the FIG. 1.

At 110, the indirect caching service publishes content via a browser page being hosted over a network at a particular site or portal. The browser page includes embedded references to objects. Client browsers download the browser page each time the user access the browser page from the client browser. Each time the browser page is downloaded to the client, the browser parses the embedded references to determine if the object names associated with the references are available in cache of the client. If they are not available in cache, then the browsers pre-acquires the objects by activating the embedded references.

According to an embodiment, at 111, the indirect caching service may set an initial cache expiration for an object to a maximum permissible period or to an indefinite period. That is, the objects may include caching attributes that instruct the browser of the client on when and how often to request updates for objects that have been pre-acquired and downloaded to the cache of the client. The indirect caching service sets these attributes to be indefinite or infinite or to a maximum permissible period. In this manner, the client browsers never or rarely request new versions or the objects downloaded into the cache. New versions of the objects are acquired in the manner discussed below.

In an embodiment, at 112, the browser page may be hosted on a WWW site or portal over the Internet on behalf of a service provider supplying a service to users over the Internet. Moreover, as was discussed at length above, at 113, the objects may be represented as references within the browser page for such things as style sheets, scripts, videos, images, graphics, audio snippets, and the like.

At 120, the indirect caching service periodically updates the browser page when an object is modified. The update is made by changing an original name of the object that is modified to a new name. This name change is reflected as a different reference within the browser page. Consequently, the client browser, when the user accesses the browser page after an update has occurred, will download a new browser page with a new name for the modified object.

This forces the browser to pre-acquire the modified object and place it in the client or browser's cache. The browser did not affirmatively request the update for the modified object; rather, the browser was forced to acquire the modified object on the first access attempt by the browser after the indirect caching service updated the browser page with the new name of the modified object. In this manner, the indirect caching service indirectly controls when the client browser performs caching and when delivery of modified objects to the client cache occurs. The old version of the object will be flushed from the client or browser cache using its own independent caching policies. Since the new version of the browser page references the new name for the object, the processing will not conflict and will not pick up the old version of the object during subsequent processing by the browser.

According to an embodiment, at 130, the indirect caching service may change the original name of a modified object to a new name using a policy. That is, the indirect caching service conforms the new name to a naming policy that it dynamically evaluates when updates are made to the browser page. In some cases, at 131, the naming policy may dictate that major and minor releases be reflected in the original and new names associated with the modified objects. So, the naming convention may be hierarchical in nature such that a first portion of the object is a descriptive name, a second portion is a major release identifier, and a final portion is a minor release identifier.

For example, suppose the modified object is feedback rating service associated with eBay®. The first part of the name for the object may be “feedback” whereas the second and third parts may reflect major and minor releases. So, an original name may be “feedback1-1,” which reflects a major release of 1 and a minor release of 1. The new name for the object may be “feedback1-2,” which reflects the same major release of 1 but a new minor release of 2. A new major release may be represented as “feedback2-1.”

A naming policy may permit the indirect caching service to create an audit trail or history for any given object in a more automated and manageable fashion, since any given name can be traced to a particular object and its particular version.

It is to be understood that the above example was presented for purposes of illustration only and is not intended to limit the teachings presented herein to any particular naming convention. Other naming conventions utilizing other characters may be used without departing from the teachings included herein.

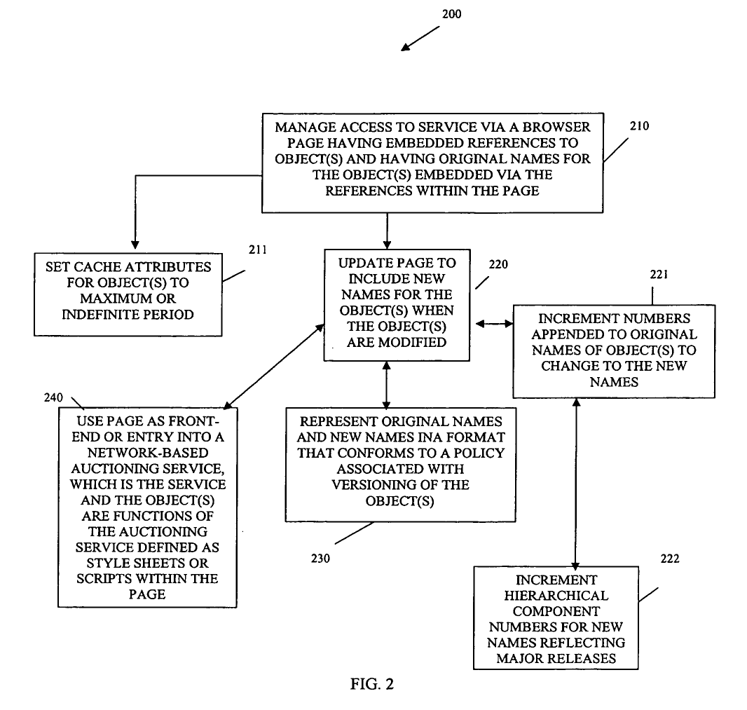

FIG. 2 is a diagram of another method 200 for an indefinite cache expiration technique, according to an example embodiment. The method 200 (hereinafter referred to as “remote cache managing service”) is implemented in a machine-accessible and/or readable medium and is accessible over a network. The remote cache managing service presents another processing perspective of the indirect caching service represented by the method 100 and presented above with respect to the discussion of the FIG. 1.

The remote cache managing service is designated as being remote since it indirectly affects or manages browser caching features by altering browser pages to include new names for modified objects; rather than permitting the browsers to repeatedly and regularly ping a server or WWW site for updates to existing objects defined in cache of the browsers. This situation and first illustration as to how it can be achieved were discussed in detail above with reference to the indirect caching service whose processing was depicted in the FIG. 1. A different perspective of that processing is presented here with reference to the FIG. 2 and the remote cache managing service.

At 210, the remote cache managing service manages access to a service via a browser page. The browser page includes embedded references to one or more objects. The objects have original names that are reflected as the embedded references within the browser page. The original version of the objects is acquired by browsers of client machines over the Internet when the browser page is first downloaded to the client machines by the browsers. That is, the browsers detect the original names as being associated with references to objects that are not present in cache. This forces the browsers to pre-acquire the objects associated with the original names and install them in browser or client cache.

In an embodiment, at 211, the remote cache managing service sets cache attributes or header information associated with the objects original acquired with the original names to a maximum or indefinite expiration period. So, the browsers will never or rarely consult the remote cache managing service for updates to the objects.

At 220, the remote cache managing service updates the browser page to include new names for the objects when the objects are modified. So, each time an object is modified it receives a new reference name within the browser page. The browser page is updated and the client browsers acquire the updated browser page each time the client browsers access the site or portal associated with the service. The updated browser page includes the new reference names for the modified objects. This forces the client browsers to pre-acquire the modified objects into cache. Essentially, the techniques of the remote cache managing service have created a situation where client browsers receive modifications to objects on demand and without unnecessary requests.

According to an embodiment, at 221, the remote cache managing service may increment numbers appended onto the original names of the objects when changing the modified objects from their original names to their new names within the browser page. Similarly, at 222, the remote cache managing service may take a more complex approach to renaming the objects to their new names such that hierarchical components of the original name are selectively incremented to reflect both major and minor releases/versions for the modified objects. An example situation such as this was presented above with the indirect caching service depicted in and described with reference to the FIG. 1.

In some cases, at 230, the remote cache managing service may represent the original and new names in a predefined format that conforms to a policy. The policy permits the names to convey versioning information for the objects and is enforced by the remote cache managing service when changing the original names to the new names.

In an embodiment, at 240, the remote cache managing service may use the browser page as a front-end or entry into a network-based auctioning service, such as eBay®. The objects represent functions of the auctioning service and may be defined as references to JavaScripts or as CSS's within the browser page.

The methods 100 and 200 may be implemented as instructions on machine-accessible media. The instructions are adapted to process the methods 100 and 200 when accessed by a machine. The media may be removable and portable, such that when it is interfaced to a media bay of a machine it is uploaded to the machine, loaded, and processed. Alternatively, the instructions may reside on a remote machine or storage media and be downloaded over a network to a machine and processed. In still other embodiments, the instructions may be prefabricated within the memory and/or storage of a machine.

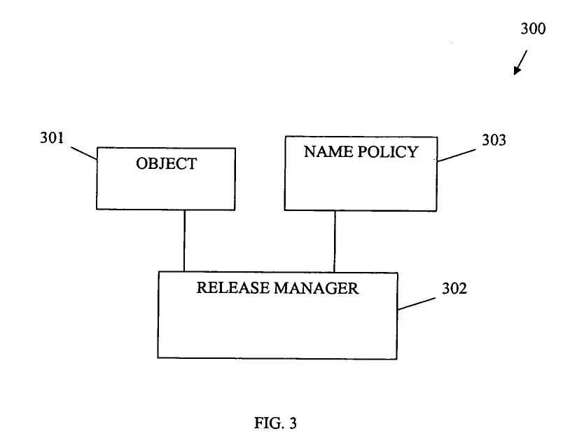

FIG. 3 is a diagram of an object release management system 300, according to an example embodiment. The object release management system 300 is implemented in a machine-accessible and/or readable medium and is accessible over a network. The object release management system 300 implements, among other things, the processing depicted by the indirect caching service and the remote cache managing service represented and described above with reference to FIGS. 1 and 2, respectively.

In an embodiment, the object release management system 300 may be implemented as a front end to a network-based service 102, such as but not limited to, a network-based auction service such as eBay® of San Jose, Calif.

The object release management system 300 includes an object 301 and a release manager 302. The object release management system 300 may also include a naming or name policy 303. Each of these components and their interaction with one another will now be discussed in turn.

The object 301 may be a script, an executable program, a style sheet, a video clip, an audio clip, a graphic, an image, etc. The object 301 is hosted on a site managed by or managed on behalf of a service provider over the Internet. The object 301 is accessed via a reference name or link, such as a Uniform Resource Locator (URL) or a Uniform Resource Identifier (URI). The reference name appears in a browser page, encoded in a browser data language, such as but not limited to HTML, XML, XSL, etc. The object 301 reference is initially set within the browser page via a first name. The first name reflects an initial or first version or release for the object 301. The object 301 when subsequently modified is referenced via a second name that reflects a subsequent version or release for the object 301.

The release manager 302 manages the object 301 and its first and second names within the browser page. The release manager also manages publishing and updating the browser page. Example processing associated with the release manager 302 was presented above with respect to the methods 100 and 200 of the FIGS. 1 and 2.

The release manager 302 changes the first name that references the object 301 within the browser page to a second name when the object 301 is modified. This forces a client browser that subsequently accesses the browser page to detect a new reference name for what appears to the client browser to be a new object. In fact, the object is not new; it is just modified and is being represented within an updated browser page as a new and second name so as to force the client browser to believe it is a new object and to request it from its source for purposes of placing it in cache for use by the browser.

The release manager 302 publishes the second name within an updated version of the browser page. In some cases, this means that the release manager interacts with a WWW site that hosts the browser page and replaces the browser page with an updated version that replaces the reference associated with the first name for the object 301 with the second name associated with a modified and updated version for the object 302.

According to an embodiment, the release manager 302 may also set a header associated with the object 301 to include a maximum period or indefinite period for requesting updates on the object 301 from a source associated with the object 301. This forces client browsers to never or rarely ask for updates to the object 301. Essentially and indefinite cache expiration is achieved on the object 301 from the perspective of the client browser. The object 301 is cached just once in cache and is flushed from cache using policy associated with the browsers and their caching services.

In an embodiment, the object release management system 300 may also include a name policy 303. The name policy 303 is evaluated and enforced by the release manager 302 and provides a naming convention for generating the second name from the first name associated with the object 301. So, the format of the first and second names may conform to a given naming policy 303, which the release manager 302 dynamically evaluates and enforces when updating the browser page with references to the second name for the object 301. Example naming conventions and policies were presented above with respect to the methods 100 and 200 of the FIGS. 1 and 2, respectively.

In some cases, the first and second names may not be related in any manner. That is, for security purposes it may be beneficial to randomly name the different versions of the object 301. This can be achieved with the teachings presented herein as well, since the release manager 302 can use a random name policy 303 that instructs it to randomly generate the second name for the object 301.

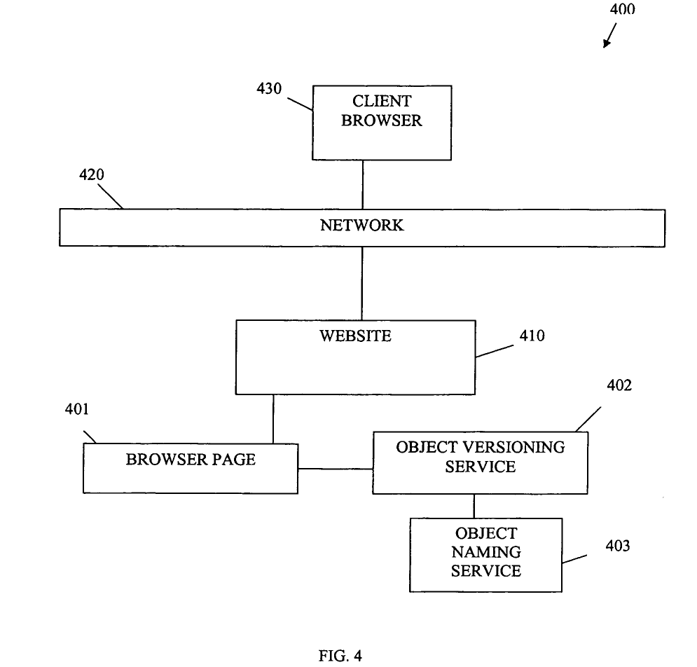

FIG. 4 is a diagram of an object versioning system 400, according to an example embodiment. The object versioning system 400 is implemented in a machine-accessible and/or readable medium and is accessible over a network. The object versioning system 400 presents another view of the object release management system 300 described with reference to the FIG. 3. Thus, the object versioning system 400 also implements, among other things, the processing depicted by the indirect caching service and the remote cache managing service represented and described above with reference to FIGS. 1 and 2, respectively.

The object version system 400 includes a browser page 401 and an object versioning service 402. In some cases, the object versioning system 400 may also include an object naming service 403. The browser page 401 is hosted on a website 410 and accessible over a network 420 by client browsers 430. Each of these components and their interaction with one another will now be discussed in turn.

The browser page 401 is included in a browser enabled data language, such as but not limited to HTML, XML, XSL, etc. The browser page 401 includes embedded references to objects. The objects may be scripts, style sheets, video clips, audio snippets, graphics, images, other executable programs or multimedia files, and the like.

The browser page 401 serves as a front-end or entry point into a desired service and it is hosted on a website 410. The client browser 430 accesses a network 420, such as through an Internet Service Provider (ISP), to gain access to the website 410 and the browser page 401 for purposes of interacting with a desired service associated with the browser page 401.

The client browser 403 maintains its own cache of objects referenced with the browser page 401, such that on subsequent accesses to the browser page 401 over the network 420, the client browser 430 may in some cases avoid a network 420 transaction entirely to acquire any given object if such object is already available from the cache of the client browser 430. To do this, the client browser 403 typically acquires the browser page 401 over the network 420 each time a user activates a link associated with the browser page 401 within the client browser 430. The browser page 401 is then scanned by the client browser 430 and any reference to objects that do not exist in cache are pre-acquired from their source over the network 420, such that they are available when the user begins to interact with the browser page 401 and the service associated therewith.

The object versioning service 402 is implemented as an object versioning means via software instructions. The object versioning service 402 maintains and manages the browser page 401 on the website 410. Moreover, each time an object is modified either in a major or minor fashion, the object versioning service 402 produces a new version of the browser page 401 that includes a new or second name for the object that was modified. This new name is then detected by the client browser 430 on the very next access attempt that the client browser 430 makes to the browser page 401 and forces the client browser 430 to request the modified object referenced by the new or second name within the browser page 401. Essentially, the objects are delivered in updated fashion to client machines as soon as a client machine attempts to access those objects after they have been modified. The old version of the objects are never or rarely requested to be updated by the client browsers 430, since the object versioning service 402 may elect to set caching attributes associated with the objects to an indefinite or maximum permissible period. This achieves indefinite cache expiration and on demand updates from the perspective of the client machines and their users and from the perspective of the website 410 service provider.

The object versioning system 400 may also include an object naming service 403. The object naming service 403 is implemented as a means for generating the second names of the objects from initial first names. The object naming service is implemented as software instructions and is interfaced to the object versioning service 402. The object naming service 403 provides instructions or policies to the object versioning service 402 such that the object versioning service is capable of producing a second name from an object that is modified from its original first name. Some example scenarios associated with naming conventions and formats were presented above with respect to the methods 100 and 200 of the FIGS. 1 and 2, respectively, and with respect to the system 300 of the FIG. 3.

One now fully appreciates how browser caching can be done on demand, such that client browsers just request updates to objects that are cached from browser page references when those objects have actually changed. This improves the processing efficiency of the client browsers and substantially reduces processing throughput and bandwidth associated with WWW sites that provide services to the clients, since the sites are not continually pinged with requests to update objects in cache and since the sites are just asked for updates to objects when the objects are actually modified. This also creates more timely distribution of modified objects to clients from the perspective of both the users associated with the clients and the service providers associated with the websites.

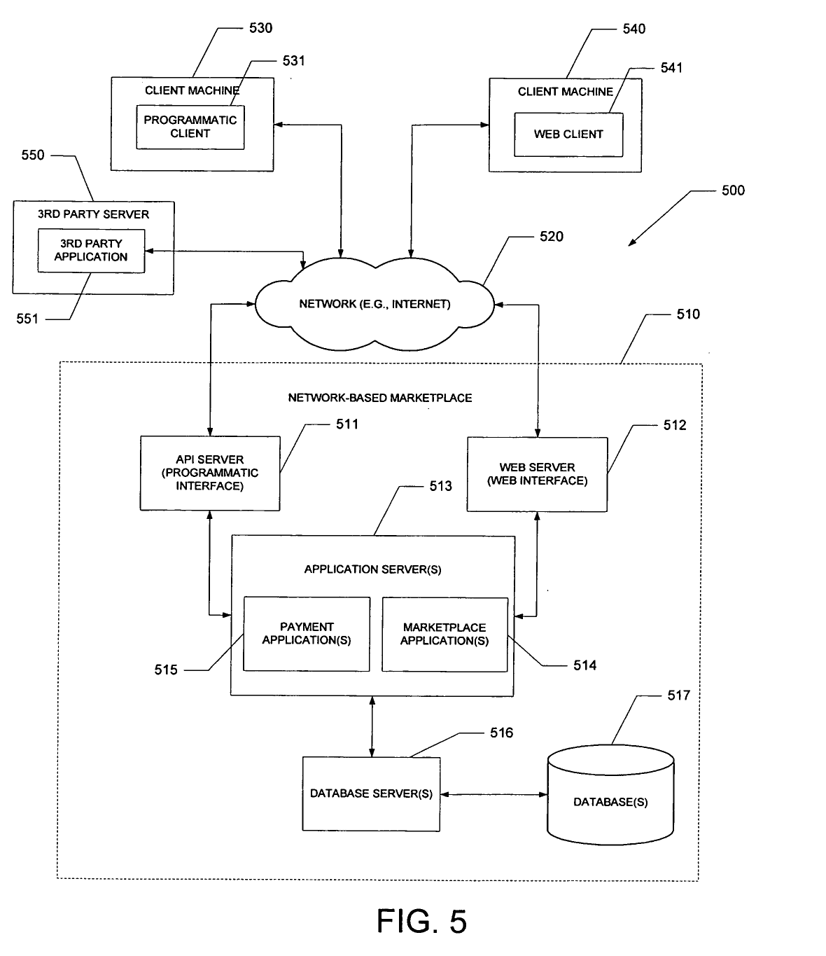

FIGS. 5-7 are now presented as example implementations of the indefinite caching expiration techniques presented herein. It is understood that these example architectures and arrangements are presented for purposes of illustration only and are not intended to limit other implementations of the teachings presented.

FIG. 5 is a diagram of example network-based commerce system or facility 500 which implements various embodiments associated with the invention. A commerce system 500, in the example form of a network-based marketplace, provides server-side functionality, via a network 520 (e.g., the Internet) to one or more clients.

FIG. 5 illustrates, for example, a web client 541 (e.g., a browser, such as the Internet Explorer browser developed by Microsoft Corporation of Redmond, Wash. State), and a programmatic client 531 executing on respective client machines 540 and 530.

An API server 511 and a web server 512 are coupled to, and provide programmatic and web interfaces respectively to, one or more application servers 513. The application servers 513 host one or more marketplace applications 514 and payment applications 515. The application servers 513 are, in turn, shown to be coupled to one or more databases servers 516 that facilitate access to one or more databases 517.

The marketplace applications 514 provide a number of marketplace functions and services to users that access the commerce system 510. The payment applications 515 likewise provide a number of payment services and functions to users. The payment applications 515 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 514. While the marketplace and payment applications 514 and 515 are shown in FIG. 5 to both form part of the commerce system 510, it will be appreciated that, in alternative embodiments, the payment applications 515 may form part of a payment service that is separate and distinct from the commerce system 510.

Further, while the system 500 shown in FIG. 5 employs a client-server architecture, the present invention is of course not limited to such an architecture, and could equally well find application in a distributed, or peer-to-peer, architecture system for example. The various marketplace and payment applications 514 and 515 could also be implemented as standalone software programs, which do not necessarily have networking capabilities.

The web client 541 accesses the various marketplace and payment applications 514 and 515 via the web interface supported by the web server 512. Similarly, the programmatic client 531 accesses the various services and functions provided by the marketplace and payment applications 514 and 515 via the programmatic interface provided by the API server 511. The programmatic client 531 may, for example, be a seller application (e.g., the TurboLister application developed by eBay Inc., of San Jose, Calif.) to enable sellers to author and manage listings on the commerce system 510 in an off-line manner, and to perform batch-mode communications between the programmatic client 531 and the network-based commerce system 510.

FIG. 5 also illustrates a third party application 551, executing on a third party server machine 550, as having programmatic access to the network-based commerce system 510 via the programmatic interface provided by the API server 511. For example, the third party application 551 may, utilizing information retrieved from the network-based commerce system 510, support one or more features or functions on a website hosted by the third party. The third party website may, for example, provide one or more promotional, marketplace or payment functions that are supported by the relevant applications of the network-based commerce system 510.

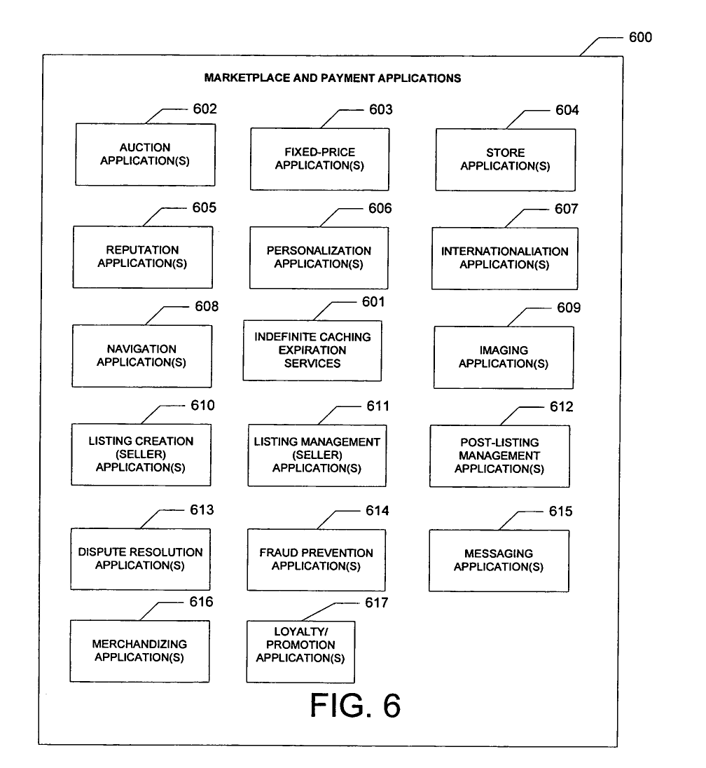

FIG. 6 is a diagram of example applications 600 implemented within some of the marketplace applications 514 of the network-based commerce system 510 of FIG. 5. The applications 600 may be hosted on dedicated or shared server machines (not shown) that are communicatively coupled to enable communications between server machines. The architecture of one such example server machine is provided below. The applications themselves are communicatively coupled (e.g., via appropriate interfaces) to each other and to various data sources, so as to allow information to be passed between the applications or so as to allow the applications to share and access common data.

The indefinite caching expiration applications 601 provide the novel indefinite caching expiration services described herein. These applications 601 are coupled or interfaced with a variety of other applications in a commerce system 510.

The commerce system 510 may provide a number of listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 600 are shown to include one or more auction applications 602 which support auction-format listing and price setting mechanisms (e.g., English, Dutch, Vickrey, Chinese, Double, Reverse auctions etc.). The various auction applications 602 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 603 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 604 allow sellers to group their listings within a “virtual” store, which may be branded and otherwise personalized by and for the sellers. Such a virtual store may also offer promotions, incentives and features that are specific and personalized to a relevant seller.

Reputation applications 605 allow parties that transact utilizing the network-based commerce system 510 to establish, build, and maintain reputations, which may be made available and published to potential trading partners. Consider that where, for example, the network-based commerce system 510 supports person-to-person trading, users may have no history or other reference information whereby the trustworthiness and credibility of potential trading partners may be assessed. The reputation applications 605 allow a user, for example through feedback provided by other transaction partners, to establish a reputation within the network-based commerce system 510 over time. Other potential trading partners may then reference such a reputation for the purposes of assessing credibility and trustworthiness.

Personalization applications 606 allow users of the commerce system 510 to personalize various aspects of their interactions with the commerce system 510. For example a user may, utilizing an appropriate personalization application 606, create a personalized reference page at which information regarding transactions to which the user is (or has been) a party may be viewed. Further, a personalization application 606 may enable a user to personalize listings and other aspects of their interactions with the commerce system 510 and other parties.

The network-based commerce system 510 may support a number of marketplaces that are customized, for example, for specific geographic regions. A version of the commerce system 510 may be customized for the United Kingdom, whereas another version of the commerce system 510 may be customized for the United States. Each of these versions may operate as an independent marketplace, or may be customized (or internationalized) presentations of a common underlying marketplace. These are represented as the internationalization applications 607 in FIG. 6.

Navigation of the network-based commerce system 510 may be facilitated by one or more navigation applications 608. For example, a search application enables key word searches of listings published via the commerce system 510. A browse application allows users to browse various category, catalogue, or inventory data structures according to which listings may be classified within the commerce system 510. Various other navigation applications may be provided to supplement the search and browsing applications.

In order to make listings, available via the network-based commerce system 510, as visually informing and attractive as possible, the marketplace applications 600 may include one or more imaging applications 609 utilizing which users may upload images for inclusion within listings. An imaging application 609 also operates to incorporate images within viewed listings. The imaging applications 609 may also support one or more promotional features, such as image galleries that are presented to potential buyers. For example, sellers may pay an additional fee to have an image included within a gallery of images for promoted items.

Listing creation applications 610 allow sellers conveniently to author listings pertaining to goods or services that they wish to transact via the commerce system 510 and listing management applications 611 allow sellers to manage such listings. Specifically, where a particular seller has authored and/or published a large number of listings, the management of such listings may present a challenge. The listing management applications 611 provide a number of features (e.g., auto-re-listing, inventory level monitors, etc.) to assist the seller in managing such listings. One or more post-listing management applications 612 also assist sellers with a number of activities that typically occurs post-listing. For example, upon completion of an auction facilitated by one or more auction applications 602, a seller may wish to leave feedback regarding a particular buyer. To this end, a post-listing management application 612 may provide an interface to one or more reputation applications 605, so as to allow the seller conveniently to provide feedback regarding multiple buyers to the reputation applications 605.

Dispute resolution applications 613 provide mechanisms whereby disputes arising between transacting parties may be resolved. For example, the dispute resolution applications 613 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 614 implement fraud detection and prevention mechanisms to reduce the occurrence of fraud within the commerce system 510.

Messaging applications 615 are responsible for the generation and delivery of messages to users of the network-based commerce system 510, such messages for example advising users regarding the status of listings at the commerce system 510 (e.g., providing “outbid” notices to bidders during an auction process or to provide promotional and merchandising information to users).

Merchandising applications 616 support various merchandising functions that are made available to sellers to enable sellers to increase sales via the commerce system 510. The merchandising applications 616 also operate the various merchandising features that may be invoked by sellers, and may monitor and track the success of merchandising strategies employed by sellers.

The network-based commerce system 510 itself, or one or more parties that transact via the commerce system 510, may operate loyalty programs that are supported by one or more loyalty/promotions applications 617. For example, a buyer may earn loyalty or promotions points for each transaction established and/or concluded with a particular seller, and may be offered a reward for which accumulated loyalty points can be redeemed.

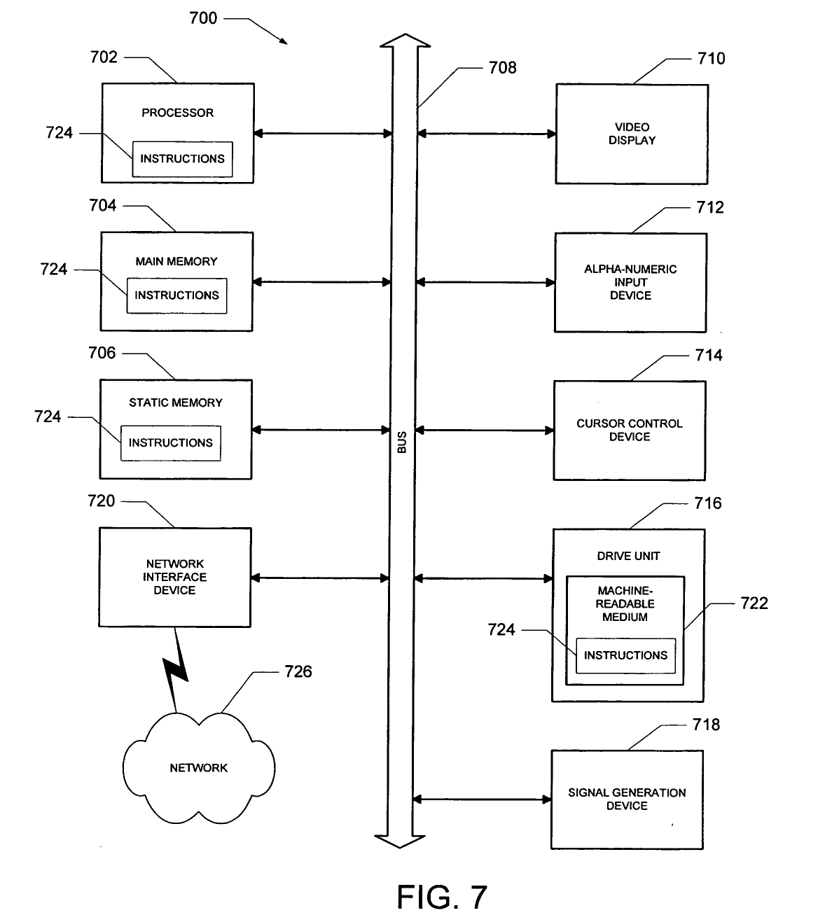

FIG. 7 is a diagram of machine architecture 700 which implements various aspects of the invention, according to an example embodiment. The machine includes a set of instructions, which when executed on the machine cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer architecture 700 includes a processor 702 (e.g., a central processing unit (CPU) a graphics processing unit (GPU) or both), a main memory 704 and a static memory 706, which communicate with each other via a bus 708. The architecture 700 may further include a video display unit 710 (e.g., a liquid crystal display (LCD) or a cathode ray tube (CRT)). The architecture 700 also includes an alphanumeric input device 712 (e.g., a keyboard), a cursor control device 814 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the architecture 700, the main memory 704 and the processor 702 also constituting machine-readable media.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to provide novel indefinite caching expiration techniques have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The above description is illustrative, and not restrictive. Many other embodiments will be apparent to those of ordinary skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A method, including:
publishing content via a browser page, wherein the content includes a reference to an object accessible from the browser page by activation of the reference; and
periodically updating the browser page by changing an original name to the reference when the object is modified and thereby forcing cache associated with a browser of an accessing client to automatically reacquire the modified object since the original name changed within the browser page.

2. The system of claim 1 further including, setting an initial cache expiration for the object to be a maximum permissible period for the browser of the client when the browser first acquires the browser page.

3. The system of claim 1 further including, conforming to a policy when changing the original name to a new name, wherein the policy makes the new name a derivative of the original name.

4. The system of claim 3, wherein conforming further includes including major release and minor release reference numbers in both the original name and the new name pursuant to the policy.

5. The system of claim 1 further including representing the object as at least one of a style sheet, a script, a video clip, an audio snippet, a graphic, and an image.

6. The system of claim 1, wherein publishing further includes hosting the browser page on a World-Wide Web (WWW) site or portal that is accessible over the Internet to the browser of the client, and wherein the browser reacquires the browser page with each reference to the WWW site.

7. A method, including:
managing access to a service via a browser page having embedded references to one or more objects, which are initially acquired by browsers of clients by activation of the embedded references and then cached by the browsers for subsequent use by the clients; and
updating the browser page to include new names to the one or more objects when the one or more objects are modified thereby forcing the browsers to reacquire the modified one or more objects when the clients access the browser page, since the new names appear to the browsers to be different objects and different from what was cached.

8. The system of claim 7, wherein managing further includes setting caching attributes associated with the one or more objects to a maximum or indefinite period when the browsers initially active the embedded references and cache the one or more objects.

9. The system of claim 7, wherein updating further includes incrementing numbers appended to original names for the one or more objects when changing the original names to the new names.

10. The system of claim 9, wherein updating further includes incrementing hierarchical component numbers associated with the original names for the one or more objects when changing the original names to the new names and when the modifications to the one or more objects reflect major releases for the one or more objects.

11. The system of claim 7 further including, representing original names associated with the one or more objects and the new names in a format that conforms to a policy associated with versioning of the one or more objects.

12. The system of claim 7 further including, using the browser page as a front-end or entry into a network-based auction service, which is the service, and the one or more objects represent functions of the network-based auction service defined as scripts or style sheets within the browser page.

13. A system, including:
an object; and
a release manager, wherein the object includes a first name associated with an initial release of the object and the first name is accessible to a browser of a client via an embedded reference to a location of the object and the embedded reference is included in a browser page with other references that is to be managed by the release manager, and wherein the release manager changes the first name to a second name within the browser page when the object is modified thereby forcing the browser of the client to reacquire the modified object when the browser page is accessed by the client.

14. The system of claim 13 further including, a name policy that is enforced by the release manager and provides a naming convention for the release manager to generate the second name from the first name.

15. The system of claim 13, wherein the release manager is set a header associated with the object to include a maximum period or indefinite period for caching that is to be used by the browser of the client thereby forcing the browser to never ask for updates to the object and to cache the object initially and once.

16. The system of claim 13, wherein the object is at least one of a script, a style sheet, a video clip, an audio snippet, a graphic, and an image.

17. The system of claim 13, wherein the release manager publishes the second name within a new version of the browser page on a World-Wide Web (WWW) site accessible to the browser of the client over the Internet.

18. The system of claim 17, wherein the browser of the client is to reacquire the browser page from the WWW site on each access attempt by the client.

19. The method of claim 18, wherein the browser of the client is to cache the object with the first name upon an initial access to the browser page and is to not request an update from the release manager on subsequent accesses to the browser page.

20. A system, including:
a browser page; and
a object versioning means, wherein the browser page includes embedded references to one or more objects having first names and the object versioning means renames the first names to second names within the browser page when the one or more objects are modified thereby forcing browsers of clients on access to the browser page to reacquire the one or more objects on demand and when the one or more objects have been modified.

21. The system of claim 20 further including, an object naming means to interface with the object versioning means for purposes of generating the second names from the first names.

22. The system of claim 20, wherein the object versioning means is to initially set caching attributes for the one or more objects to include an indefinite or maximum period for which the browsers are to request a new version of the objects from the object versioning means.

23. A machine readable medium embodying instructions that, when executed by a machine, cause the machine to perform to claim 1.
